(19) United States
(12) Patent Application Publication
(10) Pub. No.: US 2005/0013594 A1
(43) Pub. Date: Jan. 20, 2005

(54) Video recording and production systems for memorial services and other events

(76) Inventor: Quinn Eagan, New Orleans, LA (US)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/859,912

(22) Filed: Jun. 2, 2004

(51) Int. Cl. H04N 7/14; H04M 1/24; H04N 7/173; H04M 1/64; H04M 3/22; H04M 3/08; H04N 5/91; H04N 5/76; H04N 5/225

(52) U.S. Cl. 386/117; 348/14.01; 348/14.07; 348/14.03; 379/1.02; 379/67.1; 358/906

(57) ABSTRACT

A system that is configured for allowing various users to record individual video messages regarding a particular topic and then assembling segments from these video messages into a unified video presentation regarding the topic. In one embodiment, one or more video recording kiosks are provided for allowing various users to record individual video messages. The kiosks are preferably configured to transmit the various video messages to a production studio via a computer network immediately after (or as) the video messages are being recorded. The video messages are then assembled into a unified video presentation, which is then downloaded (e.g., via the computer network) for playback at a particular event. In one embodiment, one or more kiosks are provided at a wake for a recently deceased individual, and the resulting unified video presentation is assembled within 24 hours and downloaded for playback at a funeral for the recently deceased individual.

### BACKGROUND OF THE INVENTION

The current process for making memorial videos typically involves filming still photos of the individual who is being memorialized and then adding a narrated soundtrack to this footage. For example, a typical memorial video may begin with a wide angle view of a childhood picture of a recently deceased individual and continue by slowing zooming in on a particular portion of the picture (e.g., the individual's face). This portion of the video may be accompanied, for example, by a discussion of the individual's early life. The video may continue with different photos of the individual that were taken at different times during the individual's life, and a synchronized discussion of these photos.

Although such prior art videos can serve to provide a reasonably good overview of a deceased individual's life, they often lack the emotional effect desired at a funeral service. Accordingly, there is a need for improved systems and methods for producing memorial videos, as well as videos for other types of events.

### BRIEF SUMMARY OF THE INVENTION

A video recording and production system according to one embodiment of the invention comprises: (1) a video recording kiosk; (2) a server; (3) a production studio; and (4) one or more computer networks that are adapted for facilitating communication: (A) from the video recording kiosk to the server; and (B) from the server to the production studio. In this embodiment of the invention, the video recording kiosk is configured for: (1) allowing a first user to record a first video message regarding a topic during a first period of time; (2) allowing a second user to record a second video message regarding the topic during a second period of time; and (3) transmitting the first and second video messages to the server. In this embodiment, the production studio is configured for receiving the first and second video messages from the server and for assembling the first and second messages into a unified video presentation. In one embodiment of the invention, the production studio is located geographically remotely from the video recording kiosk. Also, in a particular embodiment, the video recording kiosk is disposed within a funeral home.

In one embodiment of the invention, the video recording kiosk is a first video recording kiosk; the video recording and production system further comprises a second video recording kiosk; and the one or more computer networks are adapted for facilitating communication from the second video recording kiosk to the server. In this embodiment, the second video recording kiosk is configured for: (1) allowing a third user to record a third video message regarding the topic during a third period of time; (2) allowing a fourth user to record a fourth video message regarding the topic during a fourth period of time; and (3) transmitting the third and fourth messages to the server. In addition, the production studio is configured for receiving the third and fourth messages from the server and for assembling the third and fourth messages into the unified video presentation. In one embodiment of the invention, the first video recording kiosk is disposed within a first funeral home, and the second recording kiosk is disposed within a second funeral home.

In a particular embodiment of the invention, the “topic” is a first topic, and the unified video presentation is a first unified video presentation. In this embodiment, the video recording kiosk is configured for: (1) allowing a third user to record a third video message regarding a second topic during a third period of time; (2) allowing a fourth user to record a second video message regarding the second topic during a fourth period of time; and (3) transmitting the third and fourth messages to the server. In this embodiment, the production studio is configured for receiving the third and fourth messages from the server and for assembling the third and fourth messages into a second unified video presentation. In a particular embodiment of the invention, the first, second, third and fourth periods of time fall within a single time window. In one embodiment, the first topic relates to a first recently deceased individual, and the second topic relates to a second recently deceased individual.

In a further embodiment of the invention, the “video recording kiosk” is a first video recording kiosk; the video recording and production system further comprises a second video recording kiosk; and the one or more computer networks are adapted for facilitating communication from the second video recording kiosk to the server. In one embodiment of the invention, the second video recording kiosk is configured for: (1) allowing a fifth user to record a fifth video message regarding the first topic during a fifth period of time; (2) allowing a sixth user to record a sixth video message regarding the first topic during a sixth period of time; (3) transmitting the fifth and sixth messages to the server; (4) allowing a seventh user to record a seventh video message regarding the second topic during a seventh period of time; (5) allowing an eighth user to record an eighth video message regarding the second topic during an eighth period of time; and (6) transmitting the seventh and eighth messages to the server. In a particular embodiment, the production studio is configured for: (1) receiving the fifth, sixth, seventh, and eighth video messages from the server; (2) assembling the first, second, fifth, and sixth video messages into the first unified video presentation; (3) assembling the third, fourth, seventh, and eighth video messages into the second unified video presentation; and (4) the first, second, third, fourth, fifth, sixth, seventh, and eighth periods of time fall within the single time window. In one embodiment, the first topic relates to a first recently deceased individual, and the second topic relates to a second recently deceased individual.

In one embodiment of the invention, the “topic” is a recently deceased individual, the first period of time occurs during a wake being held for the recently deceased individual, the second period of time also occurs during the wake, and the video recording and production system is configured for transmitting the unified video presentation to a video receiving computer for playback at a funeral for the recently deceased individual (which may take place, for example, on the day after the wake).

A video recording system according to a particular embodiment of the invention comprises a video camera, a computer processor, a memory, and a user interface. In this embodiment, the computer processor is configured for: (1) indicating to a user, via the user interface, that the user may record a message regarding a first topic or a second topic (this may be done, for example, by displaying the first and second topics to the user on the user interface); (2) allowing the user to select either the first topic or the second topic; (3) in response to the user selecting the first topic: (A) using the video camera to record a “first-topic” video message delivered by the user regarding the first topic, and (B) saving the “first-topic” video message to the system's memory for later use as part of a first unified video presentation regarding the first topic; and (4) in response to the user selecting the second topic: (A) using the video camera to record a “second-topic” video message delivered by the user regarding the second topic, and (B) saving the “second-topic” video message to the system's memory for later use as part of a second unified video presentation regarding the second topic.

A video recording system according to a further embodiment of the invention comprises a video camera, a computer processor, a memory, and a user interface. In this embodiment, the video recording system is configured for: (1) allowing a first user to record a first “first-topic” video message regarding a first topic during a first time period; (2) allowing a second user to record a first “second-topic” video message regarding a second topic during a second time period, the second time period occurring after the first time period; (3) allowing a third user to record a second “first-topic” video message regarding the first topic during a third time period, the third time period occurring after the second time period; (4) saving the first and second “first-topic” video messages to the system's memory for later assembly into a first unified video presentation regarding the first topic; and (5) saving the first “second-topic” video message to the system's memory for later assembly into a second unified video presentation regarding the second topic. In a particular embodiment of the invention, the video recording kiosk is disposed within a funeral home; the first topic is related to a first recently deceased individual; and the second topic is related to a second recently deceased individual.

A method of assembling a memorial video for a deceased individual according to a particular embodiment of the invention comprises the steps of: (1) providing a video recording kiosk that is adapted: (A) for allowing a first individual to record a first video message regarding a deceased individual, and (B) for allowing a second individual to record a second video message regarding the deceased individual; and (2) assembling the first and second video messages into a single memorial video for the deceased individual. In one embodiment, the method further comprises the steps of: (3) allowing the first individual to select a “key person” indicator to indicate that the first video message should be given priority treatment when the memorial video is assembled; and (4) in response to the first individual selecting the “key person” indicator, giving the first video message priority treatment when the memorial video is assembled.

One embodiment of the method described above further includes the steps of: (1) providing a second video recording kiosk that is disposed geographically remotely from the first video recording kiosk, the second video recording kiosk being adapted for allowing a third individual to record a third video message regarding the deceased individual; (2) retrieving the first and second video messages from the first video recording kiosk; (3) retrieving the third video message from the second video recording kiosk; and (4) assembling the third video message into the single memorial video for the deceased individual. In a particular embodiment, the step of assembling the first, second, and third video messages into a single memorial video is completed in less than about 24 hours of receiving a last of the first, second, and third video messages from the video recording kiosk.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of a Video Recording and Production System according to one embodiment of the present invention.

FIG. 2 is a schematic diagram of a Video Recording Kiosk according to a particular embodiment of the invention.

FIG. 3A is a side view of a Video Recording Kiosk according to a further embodiment of the invention. In this figure, the kiosk's curtain is shown in dashed lines.

FIG. 3B is a front view of the Video Recording Kiosk shown in FIG. 3A. In this figure, the kiosk's curtain is shown in dashed lines.

FIG. 4 is a schematic diagram of a Video Message Recording Computer according to an embodiment of the present invention.

FIG. 5 is a flowchart that illustrates various steps executed by a Video Message Recording Module according to a particular embodiment of the invention.

FIG. 6 depicts a topic selection screen according to one embodiment of the invention.

FIG. 7 is a flowchart that illustrates various steps executed by a First Video Message Transfer Module according to one embodiment of the invention.

FIG. 8 is a flowchart that illustrates various steps executed by a Second Video Message Transfer Module according to a particular embodiment of the invention.

FIG. 9 is a block diagram of a Video Recording and Production System according to a further embodiment of the present invention.

### DETAILED DESCRIPTION OF THE INVENTION

The present invention now will be described more fully with reference to the accompanying drawings, in which some, but not all embodiments of the invention are shown. As will be understood by one skilled in the relevant field, this invention may be embodied in many different forms and should not be construed as limited to the embodiments set forth herein. Rather, these embodiments are provided so that this disclosure will satisfy applicable legal requirements. Like numbers refer to like elements throughout.

I. System Structure and Components

As will be appreciated by one skilled in the relevant field, the present invention may be embodied as a method, a video recording and production system, and/or a computer program product. Accordingly, the present invention may take the form of an entirely hardware embodiment, an entirely software embodiment, or an embodiment combining software and hardware aspects. Furthermore, the present invention may take the form of a computer program product on a computer-readable storage medium having computer-readable program instructions (e.g., computer software) embodied in the storage medium. More particularly, the present invention may take the form of software that is implemented either partially or entirely over the Internet. Any suitable computer-readable storage medium may be utilized including hard disks, CD-ROMs, optical storage devices, or magnetic storage devices.

The present invention is described below with reference to block diagrams and flowchart illustrations of methods, apparatuses (i.e., systems) and computer program products according to various embodiments of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of elements for performing the specified functions, combinations of steps for performing the specified functions and program instructions for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

A. System Architecture

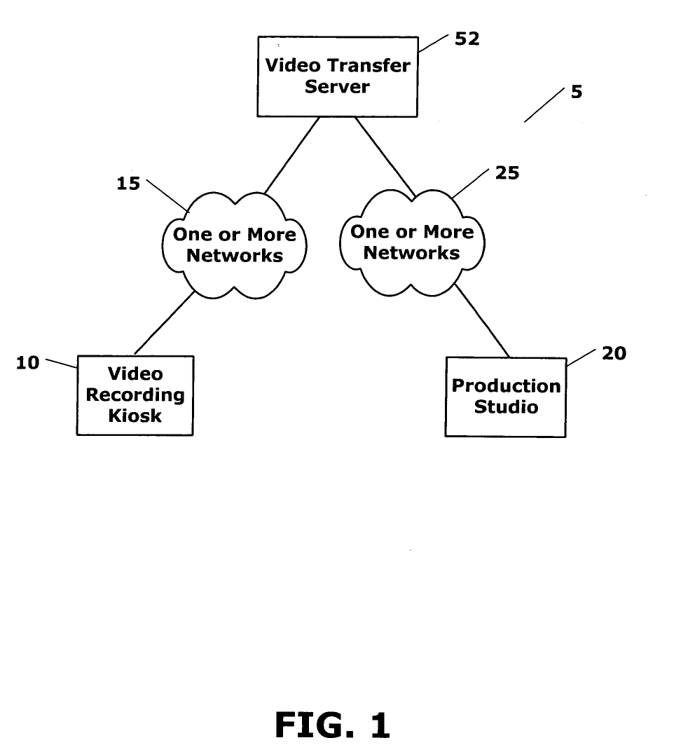

FIG. 1 is a block diagram of a video recording and production system 5 according to one embodiment of the invention. As may be understood from this figure, the system includes a video recording kiosk 10 (which may be referred to herein simply as a “kiosk”), a production studio 20, and a video transfer server 52 that is configured for facilitating the transfer of video messages from the video recording kiosk 10 to the production studio 20.

The video recording and production system 5 also includes one or more networks 15, 25 for facilitating the transfer of data, such as video messages, between the video recording kiosk 10, the video transfer server 50, and the production studio 20. As will be understood by one skilled in the art, these one or more networks 15, 25 may include, for example, the Internet and/or one or more Local Area Networks (LANs). As will also be understood by one skilled in the art, a single network or multiple networks may be used to facilitate communication between the system's various components. For example, in one embodiment of the invention, all of the system's components are connected to communicate with all other system components via the Internet.

Video Recording Kiosk

1. Overview of Kiosk Structure and Contents

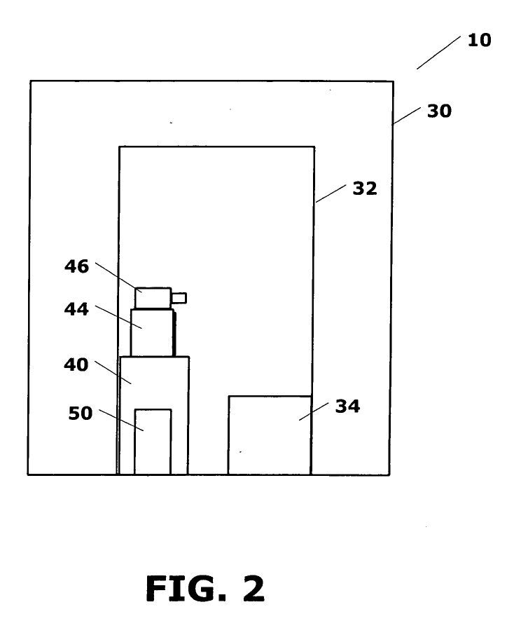

FIG. 2 is a schematic diagram of a video recording kiosk 10 according to one embodiment of the invention. In this embodiment, the video recording kiosk 10 includes an outer housing 30, which may be, for example, in the form of a booth and, more particularly, may be similar in structure to prior art automated passport photo booths.

In the embodiment of the invention shown in FIG. 2, the outer housing 30 is constructed primarily of wood and is generally in the form of a substantially rectangular box. The outer housing 30 includes a user entrance 32 that is dimensioned for allowing users to enter the kiosk 10. The kiosk 10 may also include a curtain (not shown) or door (not shown) that may be closed to ensure the privacy of users as they are using the kiosk 10 to record a video message.

In this embodiment, the kiosk 10 also includes a video message recording computer 50, a monitor 44 that is connected to the video message recording computer 50, and a video camera (e.g., a digital video camera) 46 that is connected to transfer information to and from the video message recording computer 50. In one embodiment of the invention, the video camera 46 is mounted to film users who are seated on a seat 34 provided within the kiosk 10. The video camera 46 is preferably an automatic digital camera that is adapted to automatically focus on individuals seated on the kiosk's seat 34.

In one embodiment of the invention, the video message recording computer 50 is configured (e.g., via an appropriate software application) to display messages to users via the monitor 44. The video message recording computer 50, is also preferably adapted to receive information entered by users via an appropriate user interface (e.g., a keyboard, a touch screen monitor, a mouse, a touch pad, or a microphone). In a preferred embodiment of the invention, the monitor 44 is a touch screen monitor that is configured for both displaying information to users, and for receiving information input by users by touching designated areas on the monitor's display screen. In any case, the user interface is preferably configured to be easily usable by even inexperienced and elderly users.

In one embodiment of the invention, the kiosk 10 includes an interior cabinet 40 for securely storing the video message recording computer 50 and for supporting the monitor 44 and/or the video camera 46.

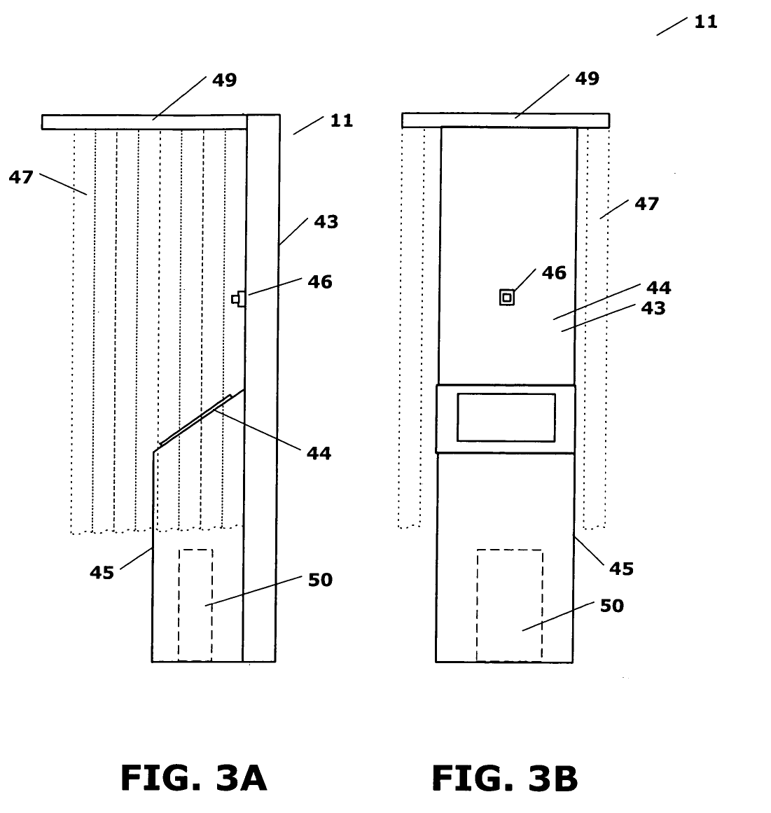

As will be understood by one skilled in the relevant field, although the kiosk is described above as being in the form a booth that is configured to be entered by a user, the kiosk may alternatively be in a “voting booth” style configuration. An example of a particular “voting booth” style kiosk 11 is shown in FIGS. 3A and 3B. As may be understood from these figures, in this embodiment, the video message recording computer 50, touch screen monitor 44, and video camera 46 are all housed within (and/or are supported by) a portable, upright structure that includes a podium-structured base portion 45 and an upright back panel portion 43 that is positioned adjacent a rear surface the base portion 45.

As shown in FIGS. 3A and 3B, the kiosk 11 may include a wrap-around curtain 47 that is positioned adjacent the monitor 44 and video camera 46. The wrap-around curtain 47 may be attached to slideably hang adjacent the monitor 44 and video camera 46 from a generally U-shaped support bar 49 so that a user may selectively open and close the curtain 47 by sliding the curtain relative to the support bar 49. This wrap-around curtain 47 is preferably configured so that when the curtain is in a closed position, the curtain surrounds the user so that the user's face (and preferably entire upper body) is obstructed from view by passers by.

The curtain 47 is preferably made of a heavy drape material that is suitable for use as a backdrop when the user is recording their message. Also, as will be understood by one skilled in the art in light of this disclosure, the curtain 47 may include either a single curtain panel, or multiple curtain panels.

2. Structure of Video Message Recording Computer

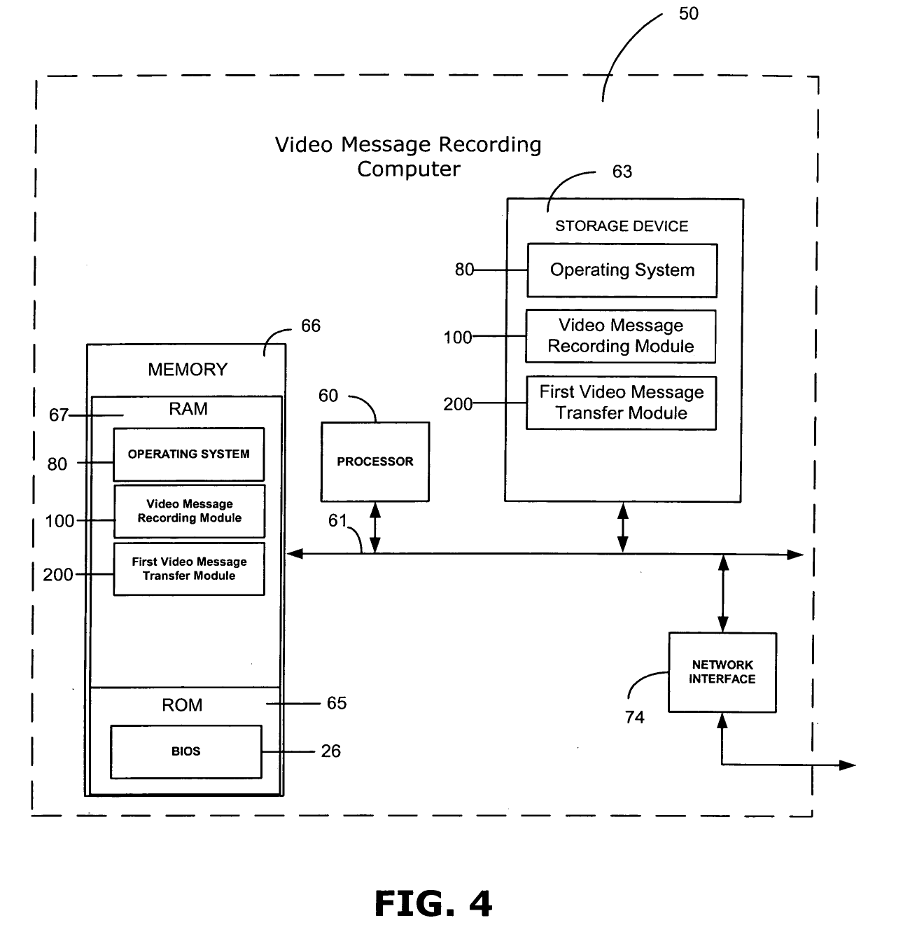

A schematic diagram of a video message recording computer 50 according to one embodiment of the invention is shown in FIG. 4. As may be understood from this figure, in this embodiment, the video message recording computer 50 includes a processor 60 that communicates with other elements within the video message recording computer 50 via a system interface or bus 61. The video message recording computer 50 further includes memory 66, which preferably includes both read only memory (ROM) 65 and random access memory (RAM) 67. The server's ROM 65 is used to store a basic input/output system 26 (BIOS), containing the basic routines that help to transfer information between elements within the video message recording computer 50.

In addition, the video message recording computer 50 includes at least one storage device 63, such as a hard disk drive, a floppy disk drive, a CD Rom drive, a DVD burner, or an optical disk drive, for storing information on various computer-readable media, such as a hard disk, a removable magnetic disk, or a CD-ROM disk or DVD. As will be appreciated by one of ordinary skill in the art, each of these storage devices 63 is connected to the system bus 61 by an appropriate interface. The storage devices 63 and their associated computer-readable media provide nonvolatile storage for a personal computer. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices and within RAM 67. Such program modules include an operating system 80, a video message recording module 100, and a first video message transfer module 200. The video message recording module 100 and first video message transfer module 200 control certain aspects of the operation of the video message recording computer 50, as is described in more detail below, with the assistance of the processor 60 and an operating system 80.

Also located within the video message recording computer 50 is a network interface 74 for interfacing and communicating with other elements of a computer network. It will be appreciated by one of ordinary skill in the art that one or more of the video message recording computer 50 components may be located geographically remotely from other video message recording computer 50 components. Furthermore, one or more of the components may be combined, and additional components performing functions described herein may be included in the video message recording computer 50.

3. Video Message Recording Module

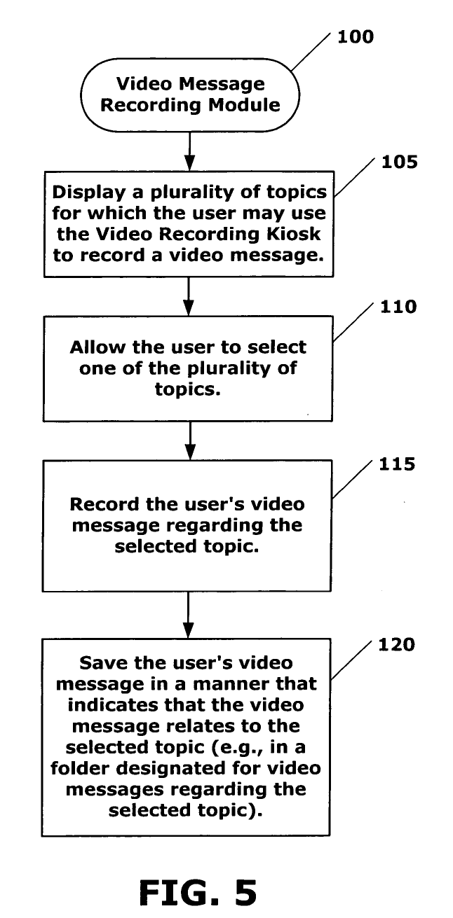

As noted above, in one embodiment of the invention, the video message recording computer 50 is configured to execute a video message recording module 100. A flow chart depicting the steps executed by a video message recording module 100 according to one embodiment of the invention is shown in FIG. 5. This embodiment of the video message recording module 100 is configured to allow users to record video messages regarding any of a plurality of topics.

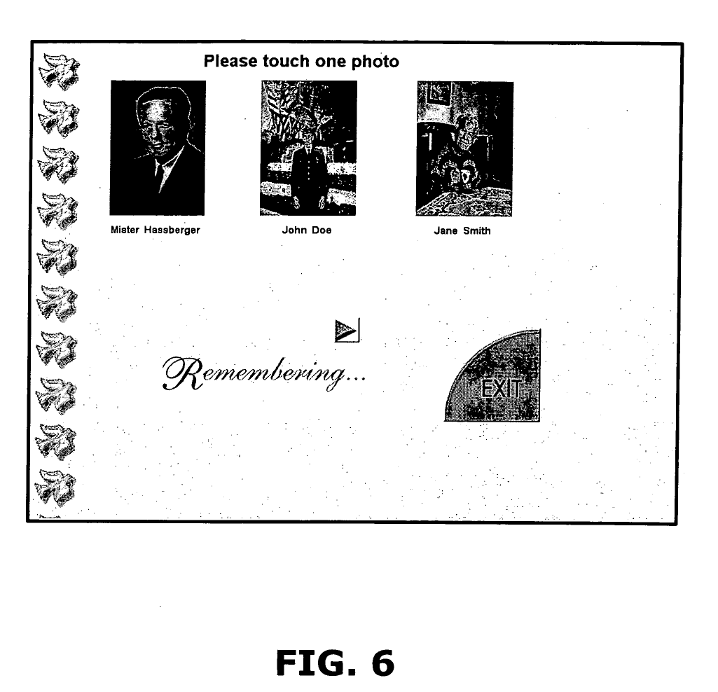

When executing the video message recording module 100 shown in FIG. 5, the video message recording computer 50 first displays a message to a user (e.g., via the kiosk's monitor 44) welcoming the user to the video recording kiosk 10. Next, at Step 105, the video message recording computer 50 displays a plurality of topics for which the user may use the video recording kiosk 10 to record a video message. For example, as shown in FIG. 6, the system may display, on a touch screen monitor 44, the names of one or more recently deceased individuals for which the user may leave a memorial video message.

Next, the video message recording computer 50 advances to Step 110 where it allows the user to select one of the plurality of topics. For example, it may allow the user to indicate that the user wishes to leave a memorial message for a particular one of the displayed plurality of recently deceased individuals by pressing the portion of the touch screen monitor 44 on which that particular individual's name is currently displayed.

Next, at Step 115, the system records the user's video message regarding the selected topic (e.g., the selected recently deceased individual). In order to allow the user time to compose their message, before executing this step, the video message recording computer 50 may display a message indicating that the user should press a particular “start” portion of the touch screen monitor 44 when they wish to start recording their video message. Similarly, the video message recording computer 50 may display a message indicating that the user should press another particular “stop” portion of the touch screen monitor 44 when they wish to stop recording their video message.

When the user is ready to record their message, the user presses the start portion of the display screen. In response to the user pressing this portion of the display screen, the video message recording computer 50 activates the video camera 46, which begins recording the user's video message. Once the user has completed their message, they press the “stop” portion of the display screen, which causes the video message recording computer 50 to deactivate the video camera. This stops the recording of the video message.

Next, the video message recording computer 50 proceeds to Step 120, where it saves the user's video message to the video message recording computer's hard drive. In a preferred embodiment of the invention, the video message recording computer 50 does this in a manner that indicates that the video message relates to the selected topic. For example, the video message recording computer 50 may save the video message to a particular folder on the system's hard drive that is designated for video messages related to the selected topic. In addition, or alternatively, the system may assign the file containing the video message a name indicating that the video message relates to the selected topic. For example, if the video message relates to the recent death of an individual named Bob Smith, the video message may be titled Bob_Smith_{—}01 to indicate that the video message is related to the topic of Bob Smith, and that the video message is the first message recorded for Bob Smith on that particular kiosk.

After the user has recorded their video message for their desired topic, they leave the video recording kiosk 10. Other users may then enter the kiosk 10 and record a video message for the same topic, or for a different topic. As a result of this process, the video message recording computer 50 may store one or more video messages for one or more topics on its hard drive at a particular time.

4. First Video Message Transfer Module

In one embodiment of the invention, the video message recording computer 50 is configured to facilitate the transfer of video messages that are recorded by the video recording kiosk 10 to the video transfer server 52. In one embodiment of the invention, the video message recording computer 50 does this by executing a first video message transfer module 200.

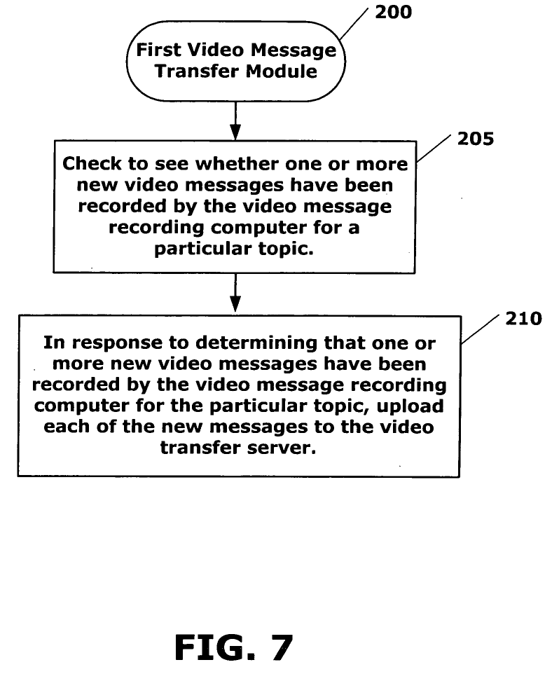

FIG. 7 is a flow chart depicting the various steps completed by the video message recording computer 50 as the video message recording computer 50 executes a first video message transfer module 200 according to a particular embodiment of the invention. As may be understood from this figure, when executing the first video message transfer module 200, the video message recording computer 50 begins at Step 205. At this step, the video message recording computer 50 checks to see whether the kiosk 10 associated with the video message recording computer 50 has recorded one or more new video messages for a particular topic. To do this, the video message recording computer 50 searches the video message recording computer's hard drive to see whether any new video message files have been added to a folder that is dedicated to a particular topic (e.g., a particular recently deceased individual).

Next, the video message recording computer 50 executes Step 210 where, in response to determining that one or more new video messages have been recorded by the video message recording computer 50 for the particular topic, the video message recording computer 50 uploads each of the new messages to the video transfer server 52 for later transfer to the production studio 20.

In one embodiment of the invention, the video message recording computer 50 is configured upload each new message to a folder on the video transfer server 52 that is dedicated to the topic of the new message. For example, if the video message recording computer 50 were to determine that a new video message file had been added to a folder on the video message recording computer 50 that is dedicated to a recently deceased individual named Bob Smith, the system would upload this new video message to a corresponding “Bob Smith” folder on the video transfer server's hard drive. As discussed below, the video transfer server 52 would then transfer the video message to the production studio 20 for processing.

In one embodiment of the invention, each video message recording computer 50 within a particular video message recording and production system executes Steps 205 and 210 on a periodic basis (e.g., every 5 minutes, every 10 minutes, every 30 minutes, or every hour) for each of its available topics. This is useful because it facilitates the transfer of the various video message files (which may be large and, therefore, time consuming to transfer) over the time period during which the video recording kiosk 10 is available to users for recording video messages. In one embodiment, this also assures that the video messages are made available to operators within the production studio 20 as the video messages become available. This serves to facilitate expedited processing of the video messages, which is especially useful when the video messages need to be reviewed, edited and included in a unified video presentation within a short period of time.

In a particular embodiment of the invention, each video message recording computer 50 within a particular video message recording and production system executes Steps 205 and 210 for each available topic on its associated video recording kiosk 10 on a periodic basis (e.g., every 5 minutes, every 10 minutes, every 30 minutes, or every hour) only while that video recording kiosk 10 is available to users for recording video messages. For example, in one example, a video transfer server 52 is associated with both a first video recording kiosk that is located in a first funeral home in Macon, Ga., and a second video recording kiosk, which is located in a second funeral home in New Orleans, La. Both of these video recording kiosks are configured to allow users to record video messages regarding both a first deceased individual, Bob Smith and a second deceased individual, Susan Jones. Also, both video recording kiosks are scheduled to be made available to users for recording video messages from 5:00 pm to 9:00 pm on June 23.

In this example, the first video recording kiosk's video message recording computer 50 checks its hard drive every five minutes from 5:00 pm-9:00 pm on June 23 to determine whether any new video messages have been left for Bob Smith. If so, the video message recording computer 50 uploads these messages to a “Bob Smith” folder on the video transfer server 52 for transfer to the production studio 20. Similarly, the second video recording kiosk's video message recording computer 50 checks its hard drive every five minutes from 5:00 pm-9:00 pm on June 23 to determine whether any new video messages have been left for Bob Smith. If so, the video message recording computer 50 uploads these messages to the video transfer server's “Bob Smith” folder for transfer to the production studio 20.

By the same token, the first video recording kiosk's video message recording computer 50 checks its hard drive every five minutes from 5:00 pm-9:00 pm on June 23 to determine whether any new video messages have been left for Susan Jones. If so, the system uploads these messages to a “Susan Jones” folder on the video transfer server 52 for transfer to the production studio 20. Similarly, the second video recording kiosk's video message recording computer 50 also checks its hard drive every five minutes from 5:00 pm-9:00 pm on June 23 to determine whether any new video messages have been left for Susan Jones. If so, the system uploads these messages to the video transfer server's “Susan Jones” folder for transfer to the production studio 20.

In an alternative embodiment, the video transfer server 52 executes Steps 205 and 210 for each available topic on each video recording kiosk associated with the video transfer server 52 on a periodic basis (e.g., every 5 minutes, every 10 minutes, every 30 minutes, or every hour) regardless of whether the video recording kiosk is available to users for recording video messages.

Video Transfer Server

In one embodiment of the invention, the video transfer server 52 comprises substantially the same structure as the video message recording computer 50 described above in regard to FIG. 3, except that rather than including a video message recording module 100 and a first video message transfer module 200, the video transfer server 52 includes a second video message transfer module 300. As noted above, in a particular embodiment of the invention, the video transfer server 52 is configured to facilitate the transfer of video messages that are recorded at the various video recording kiosks 10 to the production studio 20 for processing.

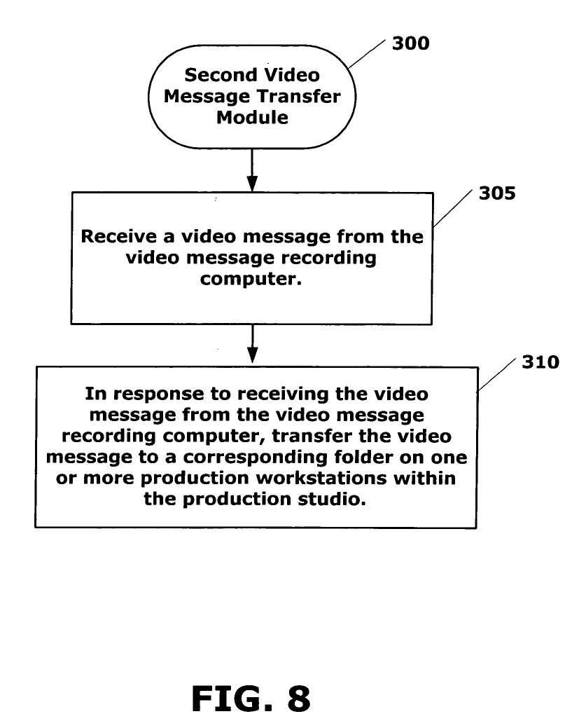

FIG. 8 is a flow chart depicting the various steps completed by the video transfer server 52 as the video transfer server 52 executes a second video message transfer module 300 according to a particular embodiment of the invention. As may be understood from this figure, when executing the second video message transfer module 300, the video transfer server 52 begins at Step 305. At this step, the video transfer server 52 receives a video message from the video message recording computer 50 (e.g., via the process described above). As noted above, in one embodiment of the invention, the video transfer server 52 receives each video message within a folder that corresponds to that particular video message's topic. For example, all new video messages that relate to Bob Smith will be uploaded to the video transfer server's “Bob Smith” folder.

Next, at Step 310, in response to receiving the video message from the video message recording computer 50, the video transfer server 52 transfers the video message from the folder in which the video message is stored on the video transfer server 52 to a corresponding folder on one or more production workstations within the production studio 20. For example, if the new video message relates to Bob Smith, the video transfer server 52 will transfer the new video message from a “Bob Smith” folder on the video transfer server 52 to a “Bob Smith” folder on one or more workstations within the production studio 20.

In one embodiment of the invention, the video transfer server 52 executes Steps 305 and 310 for video messages received from a plurality of different video message recording computers 50 regarding any of a plurality of topics. For example, the video transfer server 52 may be set up to periodically receive video messages from a first video recording kiosk that is located in a first fineral home in Macon, Ga. These video messages may regard, for example, either Bob Smith or Susan Jones, both of whom are recently deceased. Similarly, the video transfer server 52 may also be set up to periodically receive video messages from a second video recording kiosk that is located in a second funeral home in New Orleans, La. These video messages may also regard either Bob Smith or Susan Jones.

In this example, in response to receiving a particular video message, the video transfer server 52 first determines the subject to which the video message pertains (e.g., by identifying the folder in which the video message is stored on the video transfer server 52). For example, if the video message is stored in a “Susan Jones” folder on the video transfer server 52, the system would identify the message as pertaining to Susan Jones. The video transfer server 52 then transfers the video message to a “Susan Jones” folder on one or more production workstations within the production studio 20 for processing. The video transfer server 52 then repeats this process for any video messages received from the first or second video recording kiosks regarding either Bob Smith or Susan Jones.

In an alternative embodiment, the video transfer server 52 is not configured for automatically downloading the various video clips to the production studio 20. Rather, in this embodiment, the video transfer server 52 is configured to maintain copies of video message files from the various video recording kiosks 10 on the video transfer server's hard drive for later, manual download by operators within the production studio 20.

Production Studio

In one embodiment of the invention, the production studio 20 includes digital or analog equipment that is suitable for editing two or more video messages into a unified video presentation. As will be understood by one skilled in the relevant field, this may be accomplished with equipment ranging from a full, professional production studio (such as the type of studio used in commercial production facilities) to a single computer that is equipped with appropriate digital video editing software, such as Adobe Premiere Pro.

In one embodiment of the invention, the production studio 20 includes the video transfer server 52. For example, the video transfer server 52 may be a computer within the production studio 20. Alternatively, a single computer may act as both the production studio 20 and the video transfer server 52.

B. Configuration of Video Recording and Production System Components

Typically, the various video recording kiosks 10 are located geographically remotely from both the video transfer server 52 and the production studio 20. However, in other embodiments of the invention, at least one video recording kiosk 10 may be in the same building or same room as the video transfer server 52 and/or the production studio 20. In various embodiments of the invention, a video message recording computer 50 within a particular video recording kiosk 10 acts as the video transfer server 52. Alternatively, as noted above, a computer within the production studio 20 may act as the video transfer server 52.

Several examples of various configurations of the video recording and production system are listed below. However, as will be understood by one skilled in the relevant field in light of this disclosure, many other suitable configurations are possible.

### EXAMPLE 1

In one exemplary configuration, a video recording kiosk 10 is located at a first point of service (e.g., a fineral home), and the production studio 20 is located geographically remotely from the video recording kiosk 10 (e.g., in separate city or state from the video recording kiosk 10). In this example, the video transfer server 52 and production studio 20 are separate components that are located within the same production building. For example, the video recording kiosk 10 may be located at a funeral home in Macon, Ga., and the production studio 20 and video transfer server 52 may be located in a common production building in Atlanta. As noted above, in an alternative embodiment of this exemplary configuration, the video transfer server 52 and production studio 20 may be embodied in a single computer within the production building.

### EXAMPLE 2

In another exemplary configuration, both the video recording kiosk 10 and the video transfer server 52 are located at a first point of service (e.g., a fineral home). The production studio 20 is located geographically remotely from the video recording kiosk and video transfer server 52, and the video transfer server 52 and production studio 20 are separate components that are located within the same building. For example, the video recording kiosk 10 and video transfer server 52 may be located at a funeral home in Macon, Ga., and the production studio 20 may be located in a production building in Atlanta. As noted above, in one embodiment of this exemplary configuration, the video transfer server 52 may be located within, or may be part of, the video recording kiosk 10.

### EXAMPLE 3

In yet another exemplary configuration, the video recording kiosk 10, video transfer server 52 and production studio 20 are each located at different geographical locations and are, accordingly, located geographically remotely from each other. For example, in one embodiment, the video recording kiosk 10 is located in a funeral home in Macon, Ga., the production studio 20 is located in Atlanta, Ga., and the video transfer server 52 is located in Alpharetta, Ga.

### EXAMPLE 4

In a further exemplary configuration, the video recording kiosk 10, video transfer server 52, and the production studio 20 are all located in the same building. For example, in one embodiment, the video recording kiosk 10, the production studio 20, and the video transfer server 52 are all located in a funeral home in Macon, Ga. In one embodiment of the invention, the video recording kiosk 10 is located in a first room within the funeral home and the video transfer server 52 and production studio 20 are located in a second room (e.g., a production room) within the funeral home.

It should be understood in light of this disclosure that, while each of the exemplary embodiments described above is described in regard to a system having only one video recording kiosk 10, the various systems may be modified to include a plurality of video recording kiosks 10. In one embodiment of the invention, each of a plurality of video recording kiosks 10 is adapted to transfer information to a particular video transfer server 52, which then transfers the information (e.g., video messages) to a central production studio 20 for processing.

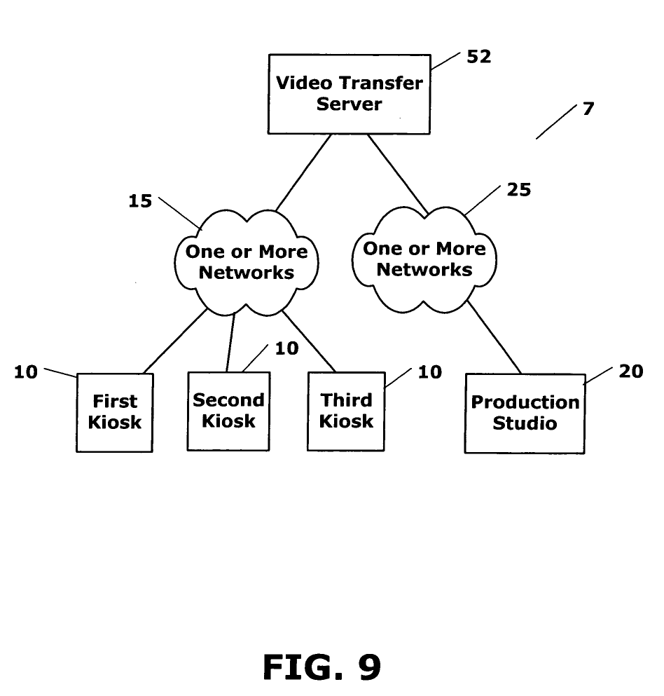

One such embodiment of the invention is shown in FIG. 9, which shows a video message recording and production system 7 according to a particular embodiment of the invention. As may be understood from this figure, three separate video recording kiosks 10 (first, second, and third kiosks 10) are connected to communicate with a single video transfer server 52 (e.g., via one or more computer networks 15, such as the Internet). In one embodiment of the invention, the first, second, and third video recording kiosks 10 are each located geographically remotely from each other (e.g., within different funeral homes in different parts of the same city, or within different funeral homes in different cities). Similarly, the video transfer server 52 is adapted to communicate with a central production studio 20 via one or more networks 25. As will be understood by one skilled in the relevant field, a single network may be used to facilitate the transfer of information between all of the various kiosks 10, the video transfer server 52, and the production studio 20.

It should be understood that, although many of the embodiments of the invention described herein use one or more computer networks to transfer information between the various system components, many of the various embodiments described herein may be implemented without a computer network. In such embodiments, for example, the various video messages may be saved to a portable storage medium (e.g., a floppy disk, CD, or DVD) and then physically transferred to the production studio 20 for processing. For example, in one embodiment of the invention, after all of the video messages are recorded by a particular video recording kiosk 10 for one or more particular topics, all of these video messages are copied onto a DVD and mailed (e.g., via overnight delivery) to a central production studio 20 for processing. The video messages are then used to assemble a unified video presentation for each of the particular topics. The completed unified video presentation may then be stored on an appropriate storage medium (e.g., a DVD) and mailed to customer for playback to a target audience.

It should also be understood that many of the various embodiments described herein may be implemented without a video transfer server 52. In one example of such an embodiment, the various video messages are manually uploaded from the various kiosks 10 to a production studio computer by a human operator on a periodic basis (e.g., every hour).

Similarly, it should be understood that various embodiments of the invention may include multiple video transfer servers 52 and/or multiple production studios 20.

II. Operation of Various Embodiments of the Invention

A. Basic Operation of Video Recording Kiosk

In various embodiments of the invention, the various video recording kiosks 10 are located in places where they can be conveniently accessed by users who may have an interest in leaving a video message regarding a particular topic. For example, a video recording kiosk 10 may be located in a reception room at a funeral home so that the friends and relatives of a recently deceased individual may use the video recording kiosk 10 to leave messages regarding the recently deceased individual.

To use a video recording kiosk 10 (See FIG. 2) according to one embodiment of the invention, a user first enters the video recording kiosk 10 and sits down on a seat 34 within the kiosk 10. The user then reads a welcome message displayed on the kiosk's monitor 44, which may, for example, explain the purpose of the kiosk 10 and ask the user to press a particular area on the kiosk's touch screen monitor 44 to proceed. The kiosk 10 then displays a list of one or more topics for which the user may leave a particular message and asks the user to select a topic for which to leave a message. For example, as shown in FIG. 6, the kiosk may display a list of recently deceased individuals and ask the user to touch the photo of the individual for whom the user wishes to leave a video message.

In response to the user selecting a particular topic (e.g., a first recently deceased individual), the kiosk displays both a “start recording” button and a “stop recording” button on the touch screen monitor 44. To start recording their message, the user presses the “start recording” button on the monitor 44. In response to the user pressing the “start recording” button, the system activates the automatic video camera 46, which then records the user's video message to the video recording computer's hard drive in a location (e.g., a particular folder) designated for storing video messages related to the selected topic (e.g., the first recently deceased individual). After the user has finished leaving their message, the user presses the “stop recording” button, which deactivates the camera 46 and resets the kiosk's video message recording computer 50 for use by the next user.

A second user may then enter the video recording kiosk 10 and use the techniques described above to either leave a message regarding the same topic as the first user (i.e., the first recently deceased individual), or a different topic (e.g., a second or third recently deceased individual). Accordingly, it should be understood that during a particular time period (e.g., from 5 pm to 9 pm on a particular day), a single video recording kiosk 10 may be used to record various video messages for each of a plurality of different topics, and may do so in any particular order. This is advantageous because, for example, it may allow different users from different groups of users to use a single kiosk 10 to record messages regarding different topics during the same time period. Thus, a single video recording kiosk 10 may simultaneously be made available to both: (1) a first group of users attending a first wake (for a first individual) at a funeral home; and. (2) a second group of users attending a second wake (for a second individual) at the same funeral home.

As noted above, in one embodiment of the invention, multiple video recording kiosks 10 that allow users to record video messages for common topics may be provided in different geographical locations. For example, in one embodiment of the invention, a first video recording kiosk 10 is provided at a first funeral home in Seattle, Wash. and a second video recording kiosk 10 is provided at a second funeral home in Atlanta, Ga. Both the first video recording kiosk 10 and the second video recording kiosk 10 are configured to allow users to record video messages related to a first recently deceased individual between 4:00 pm and 9:00 pm on Thursday, June 27. Similarly, both the first and second video recording kiosks 10 are configured to allow users to record video messages related to a second recently deceased individual between 4:00 pm and 9:00 pm on Thursday, June 27. This allows users in both Seattle and Atlanta to record video messages on the same topics during the same period of time.

In this example, the first and second video recording kiosks 10 use the techniques described above to upload the video messages recorded on both their respective hard drives to a central video transfer server 52 shortly after each message is recorded (e.g., during the 4:00 pm-9:00 pm time window on Thursday, June 27). The central video transfer server then transfers the various messages to a production studio 20 for processing. This allows operators at the production studio 20 to assemble video messages from both the first and second video recording kiosks 10 into a unified video presentation shortly (i.e., within about 24 hours) after the video messages are recorded.

In one embodiment of the invention, the system is configured to assemble the various video messages from one or more video recording kiosks 10 into a unified video presentation within about 16 to 24 hours (preferably within about 18 or about 24 hours) after the last of these various video messages is recorded, or within about 16 to 24 hours (preferably within about 18 or about 24 hours) after the completion of a specified event (e.g., a wake) at which the video messages are recorded by various users.

For example, in the example described above, if a last video message is recorded at 9:00 pm on Thursday, June 27, the system may be configured to assemble the various video messages into a unified video presentation by Friday, June 28 at 1:00 pm. The system is also preferably configured to transfer the completed unified video presentation to a video presentation receiving computer (e.g., a computer at a funeral home at which the unified video presentation will be played at a funeral) within one or more of the timeframes listed above.

As will be understood by one skilled in the relevant field in light of this disclosure, a system such as the one described above may include one, two, three, four or more video recording kiosks 10 that are all configured to allow users to record video messages regarding one or more of the same topics during the same period of time. The video messages may then be assembled into one or more unified video presentations in the manner described herein.

As noted above, once a unified video presentation is complete, the unified video presentation may be transmitted (e.g., via a computer network such as the Internet) to one or more video presentation receiving computers. The unified video presentation may then either be played to one or more audience members directly on the video presentation receiving computer or saved to an appropriate recording medium (e.g., a DVD or a VHS tape) for playback to an audience using an appropriate video player.

In one embodiment of the invention, a video recording kiosk's video message recording computer 50 acts as a video presentation receiving computer, and may be configured to record the unified video presentation to a suitable recording medium for later playback. For example, the video recording kiosk's video message recording computer 50 may include a DVD burner, which may be used to record a unified video presentation to a DVD after the unified video presentation is downloaded to the video message recording computer 50. In other embodiments of the invention, a separate computer may be used as the video presentation receiving computer.

In a particular embodiment of the invention, once the unified video presentation is complete, the unified video presentation is transmitted to a plurality of video presentation receiving computers that are located geographically remotely from each other. For example, the unified video presentation may be transmitted to a first video presentation receiving computer in Macon, Ga., and may also be transmitted to a second video presentation receiving computer in New Orleans, La. In one embodiment of the invention, this allows a plurality of funeral homes (or other businesses) that are located geographically remotely from each other to sell copies of the unified video presentation to their customers. This is useful in situations, for example, in which individuals who aren't able to attend a funeral service for a particular individual would like to participate in the memorial service by viewing the unified video presentation.

In various alternative embodiments of the invention, the unified video presentation may be transferred from the production studio to a video presentation receiving computer (or other device for playing the unified video presentation) without the use of a computer network. For example, the unified video presentation may be saved to a DVD or to a VHS tape at the production studio and then manually delivered (e.g., via an overnight delivery courier service) to the place where the unified video presentation is to be played.

B. Assembly of the Unified Video Presentation

As noted above, operators at the production studio 20 may receive various video messages regarding one or more particular topics shortly after the messages are recorded at the various video recording kiosks 10. In one embodiment of the invention, one or more producers at the production studio 20 then review the video messages for each particular topic and identify one or more video segments from each of one or more of the video messages for use within a unified video presentation for the particular topic. The producers then use known video production techniques to assemble the selected video segments into the unified video presentation. In one example, this is done by combining the selected video segments with one or more of the following: (1) pre-recorded video segments; (2) pre-compiled graphics; (3) music; (4) video of still photographs; (5) text (e.g., text generated by character generator system such those commercially available from the Chyron Corporation); and (6) voiceover recordings (such as narration regarding one or more common themes conveyed by the unified video presentation). Production studio personnel then repeat this process for each topic for which they receive video messages.

As noted above, in one embodiment of the invention, after a unified video presentation is completed for a particular topic, the unified video presentation is transmitted (e.g., via a computer network) to a video presentation receiving computer which may be located, for example, where the unified video presentation is to be shown (e.g., a funeral home). The unified video presentation is then played to an audience (e.g., at a particular event such as a funeral).

For illustrative purposes, a detailed example of the production of two unified video presentations will now be discussed. The first unified video presentation is related to a first recently deceased individual, Bob Smith, and the second unified video presentation is related to a second recently deceased individual, Susan Jones. In this example, three video recording kiosks 10 (each being in a different geographical location) are set up to record messages related to Bob Smith and Susan Jones from 5:00 pm-9:00 pm on Friday, August 20 (e.g., during wakes for these individuals). As users record video messages for Bob Smith on the three kiosks 10, the video messages are saved to a “Bob Smith” folder on a video message recording computer 50 within the particular kiosk 10 being used to record the video message. Similarly, as users record messages for Susan Jones on the three kiosks 10, the messages are saved to a “Susan Jones” folder on a video message recording computer 50 within the particular kiosk 10 being used to record the video message.

As noted above, each kiosk's video message recording computer 50 checks its “Bob Smith” folder every five minutes to determine whether there are any new video messages within that folder. If so, the video message recording computer 50 uploads the new messages to a corresponding “Bob Smith” folder on a video transfer server 52 associated with the video message recording computer 50. Similarly, each kiosk's video message recording computer 50 checks its “Susan Jones” folder every five minutes to determine whether there are any new video messages within that folder. If so, the video message recording computer 50 uploads the new messages to a “Susan Jones” folder on the video transfer server 52.

After receiving a new video message from the video message recording computer 50, the video transfer server 52 transfers the video message to an appropriate folder on one or more workstations within the production studio 20. For example, the video transfer server 52 may be configured to transfer any new messages received in its “Susan Jones” folder to a corresponding “Susan Jones” folder located on the hard drive of a particular workstation within the production studio 20.

A producer at the production studio 20 checks the folders of their production studio workstation periodically to determine whether any new video messages have arrived for particular topics that they are working on. For example, a producer assembling a unified video presentation for Bob Smith, would check a “Bob Smith” folder on his production studio workstation periodically (e.g., every 10 to 15 minutes from 5:00 pm to 9:30 pm) to determine whether any new video messages for Bob Smith have arrived. If so, the producer reviews the video messages to see whether the messages contain any segments that would fit well within a unified video presentation memorializing Bob Smith. The producer then uses any identified useful video segments (e.g., from messages recorded at any of the three video recording kiosks 10) in the process of assembling a unified video presentation memorializing Bob Smith.

After the unified video presentation is complete, production studio operators transmit the completed unified video presentation to a funeral home at which the unified video presentation is to be displayed at Bob Smith' funeral. In one embodiment of the invention, this is done by first transmitting the completed unified video presentation to a folder on the video transfer server 52 that is dedicated to files related to the subject of the unified video presentation (e.g., the video transfer server's “Bob Smith” folder). The video transfer server 52 then downloads the unified video presentation to the video message recording computer 44 of a particular video recording kiosk 10 (e.g., a kiosk within the funeral home at which the unified video presentation is to be displayed at Bob Smith' funeral.) In one embodiment of the invention, the video transfer server 52 downloads the unified video presentation to a folder on the video message recording computer 44 that is dedicated to files related to the subject of the unified video presentation (e.g., the video message recording computer's “Bob Smith” folder).

Similarly, a producer assembling a unified video presentation for Susan Jones would check a “Susan Jones” folder on his production studio workstation periodically (e.g., every 10 to 15 minutes from 5:00 pm to 9:30 pm) to determine whether any new video messages for Susan Jones have arrived. If so, the producer reviews the video messages to see whether the messages contain any segments that would fit well within a unified video presentation memorializing Susan Jones. The producer then uses any identified useful video segments (e.g., from messages recorded at any of the three video recording kiosks 10) in the process of assembling a unified video presentation memorializing Susan Jones.

After the unified video presentation is complete, production studio operators transmit the completed unified video presentation to a funeral home at which the unified video presentation is to be displayed at Susan Jones' funeral. In one embodiment of the invention, this is done by first transmitting the completed unified video presentation to a folder on the video transfer server 52 that is dedicated to files related to the subject of the unified video presentation (e.g., the video transfer server's “Susan Jones” folder). The video transfer server 52 then downloads the unified video presentation to the video message recording computer 44 of a particular video recording kiosk 10 (e.g., a kiosk within the funeral home at which the unified video presentation is to be displayed at Susan Jones' funeral.) In one embodiment of the invention, the video transfer server 52 downloads the unified video presentation to a folder on the video message recording computer 44 that is dedicated to files related to the subject of the unified video presentation (e.g., the video message recording computer's “Susan Jones” folder).

In one embodiment of the invention, the video messages are recorded during a wake for the deceased individual (e.g., Susan Jones), which occurs on a first day (e.g., a Friday), and the unified video message is transferred for playback at a funeral occurring on a second day immediately following the first day (e.g., a Saturday).

It should be understood that multiple segments may be used from any particular video message when assembling the unified video presentation. For example, in one embodiment of the invention, a producer may identify a first video segment within a particular video message regarding a first theme to be discussed within a unified video presentation. Similarly, the producer may identify a second video segment within the same particular video message regarding a second theme to be discussed within the unified video presentation. The producer may then include the first video segment in a portion of the unified video presentation exploring the first theme, and also include the second video segment in a portion of the unified video presentation exploring the second theme. The producer may use this same technique with other video messages.

For example, in one embodiment of the invention, the producer may identify a first segment of a first video message regarding the deceased individual's strength as a leader, and the producer may also identify a second segment of the first video message regarding the deceased individual's involvement in the community. Next, the producer may identify a third segment of a second video message regarding the deceased individual's strength as a leader, and they may also identify a fourth segment from the second video message regarding the deceased individual's involvement in the community. The producer may then include the first and third video segments within a portion of a unified video presentation that relates to the deceased individual's strength as a leader. Similarly, the producer may also include the second and fourth video segments within a portion of the unified video presentation that relates to the deceased individual's involvement in the community.

C. Length of the Unified Video Presentation

In one embodiment of the invention, a typical unified video presentation will be between about 4 and 8 minutes in length. However, these same techniques may be used to make longer or shorter unified video presentations. In one embodiment of the invention that is used to produce memorial videos, a first unified video of between about 4 to 10 minutes is recorded and is produced on an expedited basis (e.g., within a time frame of about 24 hours).

In one particular embodiment of the invention, the various video messages may also be used to assemble a longer, “premium” video, which may be, for example, about 30 minutes to an hour in length. Such premium videos would typically be assembled over a longer period of time (e.g., several weeks or months) and may be, for example, provided to relatives as a private keepsake. In many situations, it may be desirable to use the various video messages recorded at the various kiosks to produce both a short video on an expedited basis, and a longer “premium” video, which could be produced over a longer period of time.

III. “Key Person” Feature

In one embodiment of the invention, the video recording kiosks 10 may be configured to allow very important individuals to identify themselves as particularly important people (also referred to as “Key People”) to producers within the production studio. In one embodiment, for example, the deceased individual's closest friends and relatives may be told to press a particular button on the kiosk's touch screen monitor 44 (for example an icon in the shape of a candle) while they are recording their video message. In response to the user pressing this button while recording their video message, the system labels the file in which the video message is stored as a “Key Person file”. This serves to alert producers processing the file that they should include at least one segment from the video message within the unified video presentation.

IV. Exemplary Systems

As will be understood by one skilled in the relevant field in light of this disclosure, the above techniques may be used to assemble unified video presentations in many different contexts, especially contexts in which it is desired to assemble video messages from multiple individuals into a unified video presentation in a relatively short period of time.

For example, the techniques described above may be used in the context of a wedding celebration. More particularly, in one embodiment of the invention, one or more video recording kiosks 10 are made available during a rehearsal dinner associated with a wedding and are used to record video messages from various rehearsal dinner guests in the manner discussed above. A central video transfer server 52 then uploads the video messages to a production studio 20 (e.g., as the video messages are being recorded). The various video messages are then used, in the manner discussed above, to assemble a unified video presentation regarding the individuals being married.

In one embodiment, the unified video presentation is assembled within about 12 to about 24 hours after the rehearsal dinner's conclusion and then transmitted to a video presentation receiving computer so that the unified video presentation can be played at a celebratory event associated with the wedding (e.g., at a wedding reception following the wedding). In one embodiment of the invention, the various video messages are recorded at a rehearsal dinner, and the unified video presentation is assembled at a production studio and transmitted to the video presentation receiving computer in time to be played at a wedding reception on the following day.

In a particular embodiment of the invention, video recording kiosks are made available in locations that are geographically remote from the location of the wedding and/or rehearsal dinner so that individuals who can not attend the wedding may contribute to the unified video message to be played at the reception.

Similar techniques may be used to prepare unified video presentations for other types of events such as anniversaries, retirement celebrations, lifetime tributes, and awards, such as People's Choice Awards. In many cases, it may be advantageous to provide a nationwide or worldwide network of kiosks to allow users from around a particular country and/or from around the world to contribute messages for use within a unified video presentation.

It should be understood that, although the invention is described above with reference to various types of kiosks, in one embodiment of the invention, the video transfer server 52 and/or production studio 20 may be adapted to receive video messages recorded by individuals without using a video recording kiosk 10. For example, the video transfer server 52 may be configured to accept messages that are recorded using a web camera attached to a personal computer. Similarly, the video transfer server 52 may be configured to receive video messages that are recorded on a home digital video recorder and then uploaded (e.g., via a personal computer) to the video transfer server 52.

### V. CONCLUSION

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

1. A video recording and production system comprising:
a video recording kiosk;
a server;
a production studio; and
one or more computer networks that are adapted for facilitating communication:
(A) from said video recording kiosk to said server; and (B) from said server to said production studio, wherein
said video recording kiosk is configured for:
allowing a first user to record a first video message regarding a topic during a first period of time;
allowing a second user to record a second video message regarding said topic during a second period of time; and
transmitting said first and second video messages to said server; and
said production studio is configured for receiving said first and second video messages from said server and for assembling said first and second messages into a unified video presentation.

2. The video recording and production system of claim 1, wherein said production studio is located geographically remotely from said video recording kiosk.

3. The video recording and production system of claim 2, wherein said server is located geographically remotely from said video recording kiosk.

4. The video recording and production system of claim 1, wherein said server is located geographically remotely from said video recording kiosk.

5. The video recording and production system of claim 1, wherein said server and said production studio are located within a common building.

6. The video recording and production system of claim 1, wherein said video recording kiosk is disposed within a funeral home.

7. The video recording and production system of claim 1, wherein:
said video recording kiosk is a first video recording kiosk;
said video recording and production system further comprises a second video recording kiosk;
said one or more computer networks are adapted for facilitating communication from said second video recording kiosk to said server;
said second video recording kiosk is configured for:
allowing a third user to record a third video message regarding said topic during a third period of time;
allowing a fourth user to record a fourth video message regarding said topic during a fourth period of time; and
transmitting said third and fourth messages to said server; and
said production studio is configured for receiving said third and fourth messages from said server and for assembling said third and fourth messages into said unified video presentation.

8. The video recording and production system of claim 7, wherein said topic relates to a recently deceased individual.

9. The video recording and production system of claim 8, wherein said first video recording kiosk is disposed within a first funeral home, and said second recording kiosk is disposed within a second funeral home.

10 The video recording and production system of claim 1, wherein:
said topic is a first topic;
said unified video presentation is a first unified video presentation;
said video recording kiosk is configured for:
allowing a third user to record a third video message regarding a second topic during a third period of time;
allowing a fourth user to record a second video message regarding said second topic during a fourth period of time; and
transmitting said third and fourth messages to said server; and
said production studio is configured for receiving said third and fourth messages from said server and for assembling said third and fourth messages into a second unified video presentation; and
said first, second, third and fourth periods of time fall within a single time window.

11. The video recording and production system of claim 10, wherein:
said first topic relates to a first recently deceased individual; and
said second topic relates to a second recently deceased individual.

12. The video recording and production system of claim 10, wherein:
said video recording kiosk is a first video recording kiosk;
said video recording and production system further comprises a second video recording kiosk;
said one or more computer networks are adapted for facilitating communication from said second video recording kiosk to said server;
said second video recording kiosk is configured for:
allowing a fifth user to record a fifth video message regarding said first topic during a fifth period of time;
allowing a sixth user to record a sixth video message regarding said first topic during a sixth period of time;
transmitting said fifth and sixth messages to said server;
allowing a seventh user to record a seventh video message regarding said second topic during a seventh period of time;
allowing an eighth user to record an eighth video message regarding said second topic during an eighth period of time;
transmitting said seventh and eighth messages to said server;
said production studio is configured for:
receiving said fifth, sixth, seventh, and eighth video messages from said server;
assembling said first, second, fifth, and sixth messages into said first unified video presentation;
assembling said third, fourth, seventh, and eighth messages into said second unified video presentation; and
said first, second, third, fourth, fifth, sixth, seventh, and eighth periods of time fall within said single time window.

13. The video recording and production system of claim 12, wherein:
said first topic relates to a first recently deceased individual; and
said second topic relates to a second recently deceased individual.

14. The video recording and production system of claim 12, wherein:
said video production studio is adapted for, within about 24 hours of a last of said first, second, third, fourth, fifth, sixth, seventh, and eighth messages being transmitted to said server, executing said steps of:
assembling said first, second, fifth, and sixth messages into said first unified video presentation; and
assembling said third, fourth, seventh, and eighth messages into said second unified video presentation.

15. The video recording and production system of claim 14, wherein:
said one or more computer networks are adapted to facilitate communication between said production studio and a video receiving computer; and
said video recording and production system is configured for, within about 24 hours of a last of said first, second, third, fourth, fifth, sixth, seventh, and eighth messages being transmitted to said server, transmitting said first and second unified video presentations to said video receiving computer.

16. The video recording and production system of claim 1, wherein:
said video production studio is adapted for, within about 24 hours of said first and second messages being transmitted to said server, assembling said first and second messages into said unified video presentation.

17. The video recording and production system of claim 16, wherein:
said one or more computer networks are adapted to facilitate communication between said production studio and a video receiving computer; and
said video recording and production system is configured for, within about 24 hours of said first and second messages being transmitted to said server, transmitting said unified video presentation to said video receiving computer.

18. The video recording and production system of claim 17, wherein:
said topic is a recently deceased individual;
said first period of time occurs during a wake being held for said recently deceased individual;
said second period of time occurs during said wake; and
said video recording and production system is configured for transmitting said unified video presentation to said video receiving computer for playback at a funeral for said recently deceased individual.

19. A video recording system comprising:
a video camera;
a computer processor;
a memory; and
a user interface;
wherein, said computer processor is configured for:
indicating to a user, via said user interface, that said user may record a message regarding a first topic or a second topic;
allowing said user to select either said first topic or said second topic;
in response to said user selecting said first topic: (A) using said video camera to record a “first-topic” video message delivered by said user regarding said first topic, and (B) saving said “first-topic” video message to said memory for later use as part of a first unified video presentation regarding said first topic; and
in response to said user selecting said second topic: (A) using said video camera to record a “second-topic” video message delivered by said user regarding said second topic, and (B) saving said “second-topic” video message to said memory for later use as part of a second unified video presentation regarding said second topic.

20. A video recording system comprising:
a video camera;
a computer processor;
a memory; and
a user interface, said video recording system being configured for:
allowing a first user to record a first “first-topic” video message regarding said first topic during a first time period;
allowing a second user to record a first “second-topic” video message regarding said second topic during a second time period, said second time period occurring after said first time period;
allowing a third user to record a second “first-topic” video message regarding said first topic during a third time period, said third time period occurring after said second time period;
saving said first and second “first-topic” video messages to said memory for later assembly into a first unified video presentation regarding said first topic; and
saving said first “second-topic” video message to said memory for later assembly into a second unified video presentation regarding said second topic.

21. The video recording system of claim 20, wherein said video recording system is disposed substantially within a video recording kiosk.

22. The video recording system of claim 21, wherein:
said video recording kiosk is disposed within a funeral home;
said first topic is related to a first recently deceased individual; and
said second topic is related to a second recently deceased individual.

23. The video recording system of claim 20, wherein:
said first topic is related to a first recently deceased individual; and
said second topic is related to a second recently deceased individual.

24. A method of assembling memorial video for a deceased individual, said method comprising the steps of:
providing a video recording kiosk that is adapted: (1) for allowing a first individual to record a first video message regarding a deceased individual, and (2) for allowing a second individual to record a second video message regarding said deceased individual; and
assembling at least a portion of said first video message and at least a portion of said second video message into a single memorial video for said deceased individual.

25. The method of claim 24, further comprising the step of allowing said first individual to select a “key person” indicator to indicate that said first video message should be given priority treatment when said memorial video is assembled; and
in response to said first individual selecting said “key person” indicator, giving said first video message priority treatment when said memorial video is assembled.

26. The method of claim 24, further comprising the step of, before assembling said first and second video messages into a single memorial video, retrieving said first and second video messages from said video recording kiosk.

27. The method of claim 26, wherein said assembling step is completed in less than about 24 hours of receiving said first and second video messages from said video recording kiosk.

28. The method of claim 24, wherein said step of providing a video recording kiosk comprises providing said video recording kiosk at a funeral home.

29. The method of claim 24, wherein said method further comprises the step of providing a production studio and executing said assembling step at said production studio.

30. The method of claim 29, wherein said production studio is disposed geographically remotely from said video recording kiosk.

31. The method of claim 24, wherein said video recording kiosk is a first video recording kiosk, and said method further includes the steps of:
providing a second video recording kiosk that is disposed geographically remotely from said first video recording kiosk, said second video recording kiosk being adapted for allowing a third individual to record a third video message regarding said deceased individual;
retrieving said first and second video messages from said first video recording kiosk;
retrieving said third video message from said second video recording kiosk; and
assembling said third video message into said single memorial video for said deceased individual.

32. The method of claim 31, wherein said step of assembling said first, second, and third video messages into a single memorial video is completed in less than about 24 hours of receiving a last of said first, second, and third video messages.

33. A video recording and production system comprising:
a video recording kiosk;
a production studio; and
one or more computer networks that are adapted for facilitating communication from said video recording kiosk to said production studio, wherein
said video recording kiosk is configured for:
allowing a first user to record a first video message regarding a topic during a first period of time;
allowing a second user to record a second video message regarding said topic during a second period of time; and
transmitting said first and second video messages to said production studio; and
said production studio is configured for receiving said first and second video messages from said video recording kiosk and for assembling said first and second messages into a unified video presentation.
